(19) United States
(12) Patent Application Publication
(10) Pub. No.: US 2005/0200770 A1
(43) Pub. Date: Sep. 15, 2005

(54) Flat panel display

(76) Inventors: Han-Ping Kuo, Taipei City (TW); Hsin-Yuan Chuang, Ligang Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/797,214

(22) Filed: Mar. 10, 2004

(51) Int. Cl. G02F 1/1333

(52) U.S. Cl. 349/58

(57) ABSTRACT

A flat panel display. The flat panel display includes a frame, a panel, and a backlight unit. The panel is disposed in the frame. The backlight unit, disposed in the frame, comprises a plurality of optical films, a light source, a light guide plate, and a reflector surrounding the light source and the light guide plate. One of the optical films has a first end, and the reflector has a second end in the vicinity of the optical films, with the first end level with or facing the second end.

### BACKGROUND OF THE INVENTION

1. Field of the Invention

The present invention relates to a flat panel display and in particular to a flat panel display having a backlight with a compact profile.

2. Description of the Related Art

Flat panel displays such as liquid crystal displays (LCDs) have been used as image display devices in a variety of electronic devices, including notebook and desktop computer monitors, television sets, car navigation systems, and mobile information appliances.

A conventional design is shown in FIG. 1. The light crystal display 10′ comprises a liquid crystal panel 2′, a backlight unit 4′, a shield casing 6′, and a plastic frame 8′.

The liquid crystal panel 2′ is formed by a pair of transparent substrate plates 22a′ and 22b′ with liquid crystal 20′ sandwiched therebetween.

The backlight unit 4′, having a plurality of optical films 41′, a light guide plate 42′, a light source (CCFL) 43′, and a reflector 44′, is disposed along the rear face of the liquid crystal panel 2′ supplying light from the light source 43′ to the rear face. The rectangular reflector 44′ surrounds the light source 43′ and the light guide plate 42′. The optical films 41′ are disposed above and along an upper surface 44a′ of the reflector 44′.

The shield casing 6′, referred as a bezel, comprises an upper and lower casing 6a′ and 6b′, covering entire periphery and its vicinity for reduction of electromagnetic noise and enhancing mechanical strength of the liquid crystal display 10′.

The plastic frame 8′ is usually made of resin and formed by injection molding, having a protruding portion 8a′ extending toward the interior, supporting the substrate 22b′ of the panel 2′.

FIG. 1B is an enlarged schematic diagram of FIG. 1A. Since the protruding portion 8a′ between the panel 2′ and the optical films 41′ is integrally formed with the plastic frame 8′ by injection molding, the protruding portion 8a′ has a minimum thickness D to maintain strength thereof. Furthermore, the protruding portion 8a′ functions as a supporting element for the panel 2′ from the rear thereof. Thus, the protruding portion 8a′ cannot undergo size reduction or elimination. Because the elements of the liquid crystal display mentioned above are indispensable to a liquid crystal display 10′, there must be a gap with a thickness of H₁ between the panel 2′ and the films 41′. Consequently, the total thickness of the display cannot be reduced.

Also, since the optical films 41′ are arranged between the protruding portion 8a and the upper surface 44a′ of the reflector 44′, if any unwanted particles enter therein, the plastic frame 8′ must be removed and reassembled in order to remove the particles, requiring additional time for the cleaning process during assembly.

Hence, there is a need for an improved arrangement of essential elements in a flat panel display that can provide a compact and narrower profile, and eliminate the other shortcomings described.

### SUMMARY OF THE INVENTION

Thus, an object of the invention is to provide a flat panel display with a modified arrangement between the optical films and the reflector such that the profile is as thin and light as possible, and eliminate the other shortcomings described.

The present invention provides a flat panel display comprising a frame, a panel, and a backlight unit. The panel is disposed in the frame. The backlight unit, also disposed in the frame, comprises a plurality of optical films, a light source, a light guide plate, and a reflector surrounding the light source and the light guide plate. One optical film has a first end, and the reflector has a second end in the vicinity of the optical films, with the first end level with or facing the second end.

The frame has a protruding portion, disposed between the reflector and the panel and supporting the panel.

The flat panel display further comprises at least one fixing element, fixing the optical films and the reflector.

The fixing element comprises a tape, either transparent or opaque.

Accordingly, the frame is made of plastic.

The flat panel display further comprises a bezel, surrounding the frame and supporting the panel.

In one embodiment, the reflector is a reflective lamp holder.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic cross section of a conventional liquid crystal display;

FIG. 1B is an enlarged view of FIG. 1A;

FIG. 2A is a schematic cross section of a liquid crystal display according to the present invention;

FIG. 2B is an enlarged view of FIG. 2A;

FIG. 3A is a schematic cross section of a liquid crystal display according to a varied embodiment of the present invention; and

FIG. 3B is an enlarged view of FIG. 3A.

### DETAILED DESCRIPTION OF THE INVENTION

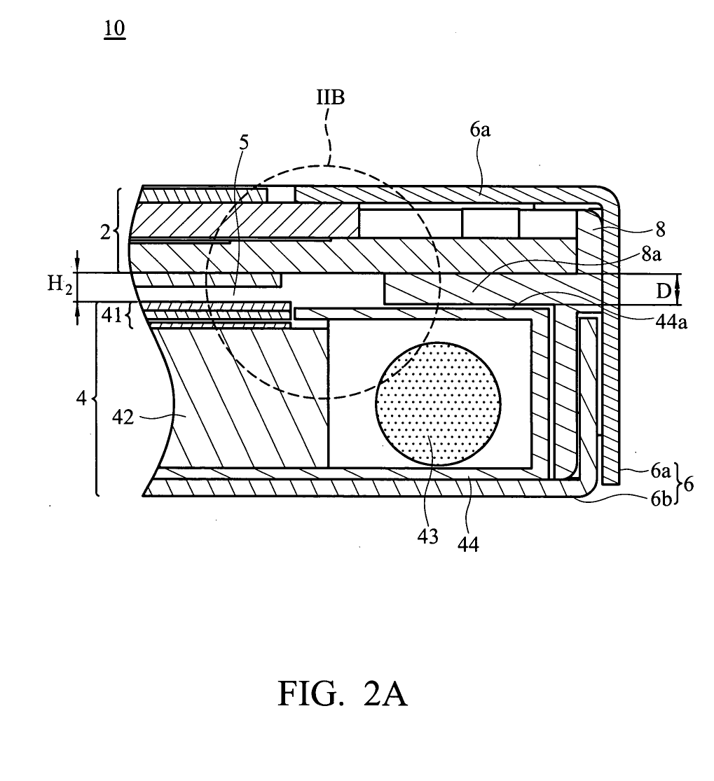

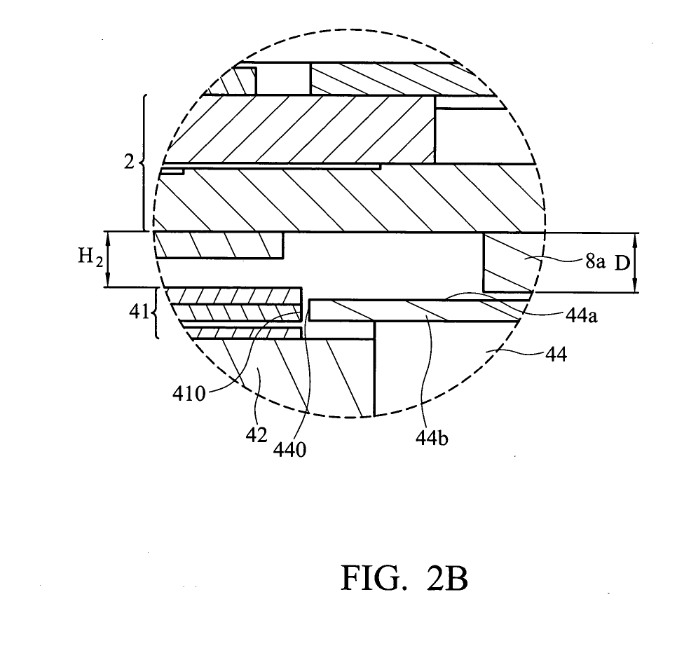

FIG. 2A is a schematic cross section of a liquid crystal display according to the present invention. The liquid crystal display 10 comprises a bezel 6, a plastic frame 8, a panel 2, and a backlight unit 4. The bezel 6 may be metal and includes upper and lower portions 6a and 6b, covering the periphery and vicinity to reduce electromagnetic noise and enhance mechanical strength of the liquid crystal display 10.

The plastic frame 8 is usually made of resin and formed by injection molding, having a protruding portion 8a with a minimum thickness of D extending toward the interior, supporting the panel 2. The upper portion 6a of the bezel 6 covers the plastic frame 8, and the lower portion 6b is partially sandwiched between the plastic frame 8 and the upper portion 6a of the bezel 6.

The backlight unit 4 having a plurality of optical films 41, a light guide plate 42, a light source (CCFL) 43, and a reflector 44, is disposed below the liquid crystal panel 2 and supplies a light from the light source 43 to the rear face of the panel 2.

The reflector 44 or a reflective lamp holder with a picture-frame shape surrounds the light source 43 and the light guide plate 42. The light source 43 is disposed at one end of the light guide plate 42 and near the plastic frame 8. The optical films 41 are disposed above and along the light guide plate 42.

It is to be noted that the reflector 44 has an upper surface 44a positioned between the light source 43 and the protruding portion 8a and extends toward the optical films 41. In FIG. 2B, an enlarged view of FIG. 2A, the upper surface 44a of the reflector 44 has a first end 440 levels with or facing a second end 410 of one of the optical films 41.

In this embodiment, the second end 410 is an end of the optical film positioned in the middle. In a varied embodiment, the first end 440 of the reflector 44 may be level with an end of the most top optical film (not shown). The present invention modifies arrangement between the optical films 41 and the reflector 44 to minimize the gap H₂ between the panel 2 and the backlight unit 4, providing a compact profile LCD.

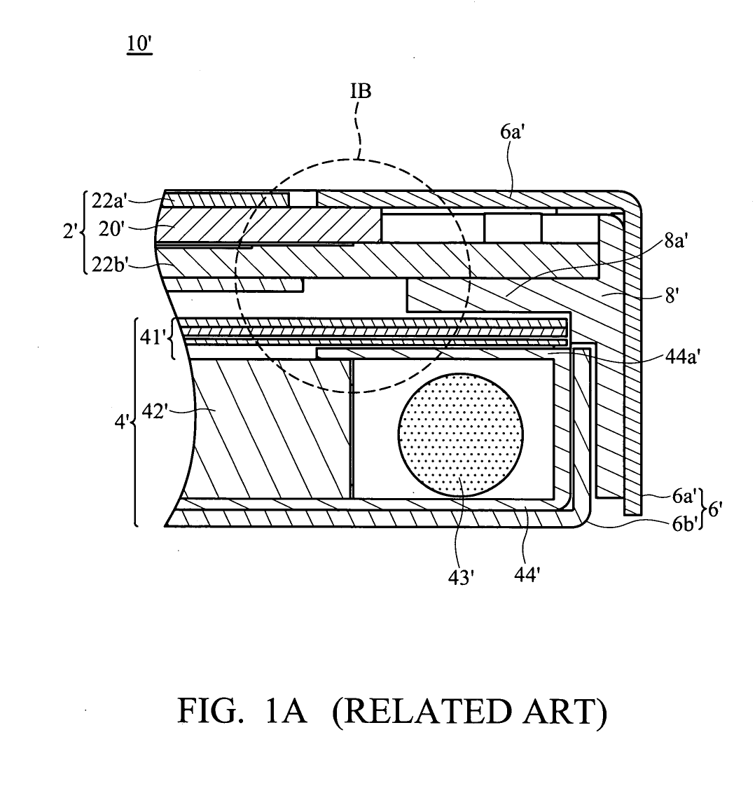

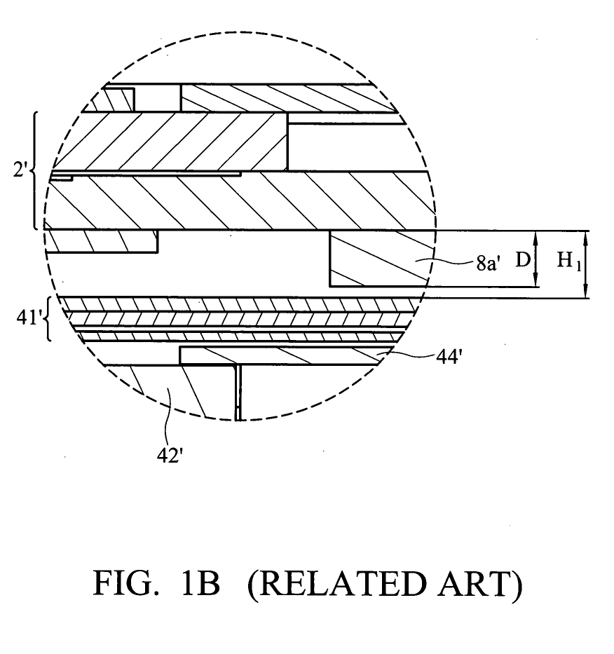

In FIG. 2B, it can be clearly seen that the gap H₂ between the panel 2 and the films 41 is less than the thickness D of the protruding portion 8a. Compared to the conventional LCD, the gap H₁ between the panel 2′ and the films 41′ as shown in FIG. 1B is larger than the thickness D of the protruding portion 8a. Therefore, the gap H₂ according to the present invention is less than the gap H₁ of the conventional LCD. Consequently, the total thickness of the display is further reduced due to the modified space arrangement between the optical films 41 and the reflector 44.

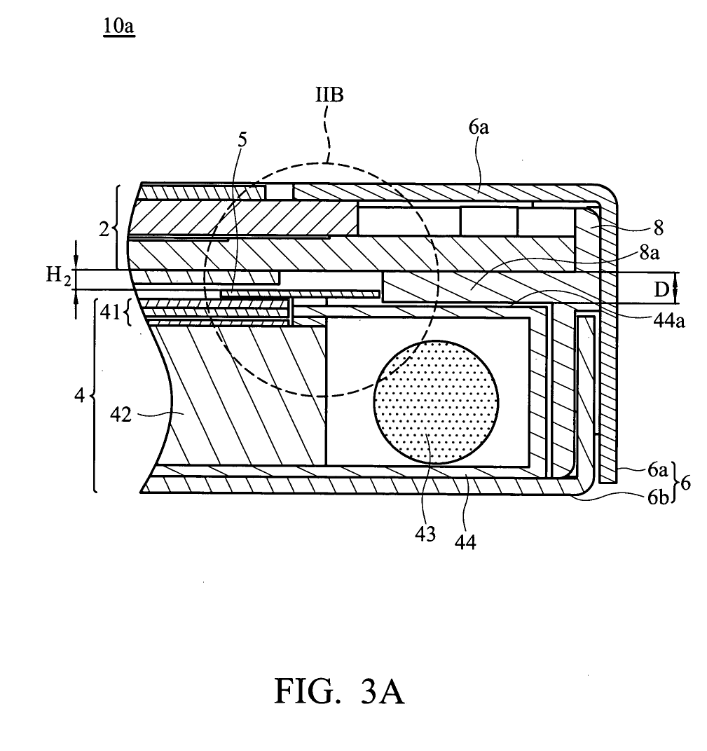

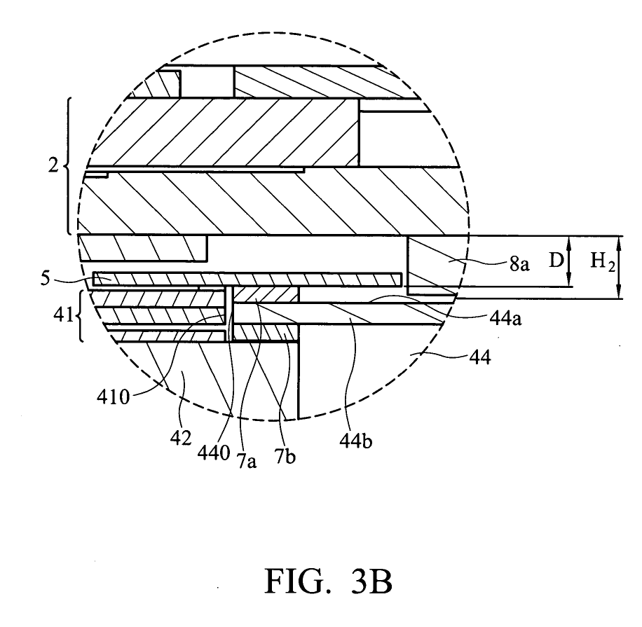

Furthermore, in a varied embodiment, as shown in FIGS. 3A and 3B, after assembly of the backlight unit 4, if subsequent assembly is processed in a separate production line or in a different facility, to prevent displacement during transport, a primary fixing element 5 such as a tape or a film is disposed across the optical films 41 and the reflector 44.

In another varied embodiment, also shown in FIGS. 3A and 3B, a secondary fixing element 7a can be added between the upper surface 44a of the reflector 44 and the primary fixing element 5. Another secondary fixing element 7b can be disposed between the lower surface 44b of the reflector 44 and the light guide plate 42. Thus, the improved arrangement between the reflector 44 and the optical films 41 can be structurally enhanced by the primary and secondary fixing elements, 5, 7a, and 7b.

Moreover, the fixing elements 5, 7a, and 7b mentioned above can be either transparent or opaque. In a large-sized panel, the optical films 44 are longer, and light may partially escape from the gap between the first end 440 of the reflector 44 and the second end 410 of one optical film 41. Even so, brightness of the liquid crystal display is not affected because the escaping light is relatively insignificant, and thus, the fixing elements 5, 7a, and 7b can be made transparent only for fixing purpose.

In a small-sized panel, the optical films 41 are shorter and the amount of light reflected from the light source 43 becomes an important factor for brightness of the LCD. Thus, the fixing element 5 must be made opaque to minimize loss of light through the gap between the first end 440 of the reflector 44 and the second end 410 of one of the optical films 41. Thus, the opaque fixing elements 5, 7a, and 7b not only strengthen the structure but also prevent loss of light.

Hence, if the dimensions of the elements in an LCD such as light guide plate 42 and panel 2 remain unchanged, the rearranged structure between the optical films 41 and the reflector 44 according to the present invention provides an enhanced and narrower profile without affecting light intensity and image quality of the LCD.

In addition, if the LCD requires higher light intensity, since the gap between the reflector 44 and the panel 2 is minimized, there is more room for the light guide plate 42 of the backlight unit 4 to be enlarged for increased brightness.

Another advantage of the present invention is, if during assembly of the backlight unit 4, any foreign particles intervene therein, since the optical films 41 are not covered by the plastic frame 8, it is easier and faster to remove the particles from the optical films 41, thereby reducing the extra time for reassembly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A flat panel display comprising:
a frame;
a panel, disposed in the frame; and
a backlight unit, further disposed in the frame, comprising a plurality of optical films, a light source, and a reflector surrounding the light source;
wherein one of the optical films comprises a first end, and the reflector comprises a second end in the vicinity of the optical films, the first end level with the second end.

2. The flat panel display as claimed in claim 1, wherein the frame comprises a protruding portion, disposed between the reflector and the panel and supporting the panel.

3. The flat panel display as claimed in claim 1, further comprising at least one fixing element, fixing the optical films and the reflector.

4. The flat panel display as claimed in claim 4, further comprising a light guide plate disposed under the optical films.

5. A flat panel display comprising:
a panel; and
a backlight unit, comprising at least a plurality of optical films, a light source, and a reflector surrounding the light source;
wherein one of the optical films comprises a first end, and the reflector comprises a second end in the vicinity of the optical films, the first end level with the second end.

6. The flat panel display as claimed in claim 5, further comprising a frame.

7. The flat panel display as claimed in claim 6, wherein the frame comprises a protruding portion, disposed between the reflector and the panel and supporting the panel.

8. The flat panel display as claimed in claim 6, further comprising at least one fixing element, fixing the optical films and the reflector.

9. The flat panel display as claimed in claim 6, further comprising a light guide plate disposed under the optical films.

10. A flat panel display comprising:
a frame;
a panel, disposed in the frame; and
a backlight unit, disposed in the frame, comprising a plurality of optical films, a light source, and a reflector surrounding the light source;
wherein one of the optical films comprises a first end, and the reflector comprises a second end in the vicinity of the optical films, the first end facing the second end.

11. The flat panel display as claimed in claim 10, wherein the frame comprises a protruding portion, disposed between the reflector and the panel and supporting the panel.

12. The flat panel display as claimed in claim 10, further comprising at least one fixing element, fixing the optical films and the reflector.

13. A flat panel display comprising:
a panel; and
a backlight unit, comprising at least a plurality of optical films, a light source, and a reflector surrounding the light source;
wherein one of the optical films comprises a first end, and the reflector comprises a second end in the vicinity of the optical films, the first end facing the second end.

14. The flat panel display as claimed in claim 13, further comprising a frame.

15. The flat panel display as claimed in claim 14, wherein the frame comprises a protruding portion, disposed between the reflector and the panel and supporting the panel.

16. The flat panel display as claimed in claim 14, further comprising at least one fixing element, fixing the optical films and the reflector.

17. The flat panel display as claimed in claim 13, further comprising a light guide plate disposed under the optical films.
